(19) United States
(12) Patent Application Publication
(10) Pub. No.: US 2009/0101631 A1
(43) Pub. Date: Apr. 23, 2009

(54) SYSTEM FOR CONTROLLING HIGH CURRENT COMPONENTS IN A MOTOR VEHICLE

(76) Inventors: Tracy M. Farell, Grand Blanc, MI (US); Steven Douglas Stiles, Clarkston, MI (US)

Correspondence Address: GENERAL MOTORS CORPORATION;LEGAL STAFF, MAIL CODE 482-C23-B21, P O BOX 300, DETROIT, MI, 48265-3000, US

(21) Appl. No.: 11/877,471

(22) Filed: Oct. 23, 2007

(51) Int. Cl. B60L 1/08; G06F 19/00

(52) U.S. Cl. 219/202; 701/36

(57) ABSTRACT

A control system for controlling high current devices in a vehicle is disclosed. The system includes a power source, a first and a second plurality of high current devices and a high current device control module. The high current device control module is connected to the power source and has a multiplexer circuit and a plurality of driver circuits connected to the first and second plurality of high current devices. The multiplexer circuit is in communication with the plurality of driver circuits to selectively activate the first plurality of high current devices or the second plurality of high current devices.

### FIELD

The invention relates generally to a system for controlling components in a motor vehicle. More particularly, the invention relates to a system for controlling high current components such as heaters, glow plugs and similar devices in motor vehicles.

### BACKGROUND

During normal operating conditions, a motor vehicle emits nitrogen oxides (NOx) and particulates in an exhaust gas stream as by-products of, for example, combustion in a diesel engine. An exhaust system is used to receive the exhaust gas and at least partially remove the unwanted by-products from the exhaust prior to entry into the surrounding environment. The exhaust system typically employs various devices and methods for removing these by-products. For example, one effective method of reducing the NOx by-products from the exhaust gas is using selective catalytic reduction (SCR). Conventional SCR devices use an ammonia reductant to react with the NOx to produce Nitrogen gas and water vapor. However, the use of ammonia as a reductant can be undesirable in motor vehicles as the ammonia presents issues in storage and transport.

One solution is to replace the ammonia in the SCR system with a urea reductant. Urea is a compound that effectively reacts with the NOx to remove the NOx from the exhaust stream. However, urea must be in its active gaseous state to effectively react with the NOx which may require heating of the urea. Urea heaters have been used to heat the urea, but these heaters require a high current that is not easily provided in a typical motor vehicle. More specifically, the urea heaters require control circuitry that is capable of withstanding and dissipating the heat generated by supplying the high current.

One solution is to add dedicated control circuitry capable of independently driving the urea heaters. However, this solution is costly and adds complexity to the control system. Accordingly, there is a need in the art for a system for controlling high current components in a motor vehicle that minimizes the need for additional control circuitry and components.

### SUMMARY

The present invention provides a control system for controlling high current devices in a vehicle having a diesel engine. The system includes a power source, a first and a second plurality of high current devices and a high current device control module. The power source provides a supply current. The first and second plurality of high current devices are selectively connectable to the power source to receive the supply current. The high current device control module is connected to the power source and has a multiplexer circuit and a plurality of driver circuits connected to the first and second plurality of high current devices. The multiplexer circuit is in communication with the plurality of driver circuits to selectively activate the first plurality of high current devices or the second plurality of high current devices.

In one aspect of the present invention, the plurality of driver circuits are equal in number to one of the first and second plurality of high current devices.

In another aspect of the present invention, a plurality of control lines are connected to the driver circuits and the plurality of control lines are equal in number to one of the first and second plurality of high current devices

In yet another aspect of the present invention, the first plurality of high current devices are a plurality of glow plugs.

In yet another aspect of the present invention, the second plurality of high current devices are a plurality of heaters.

In yet another aspect of the present invention, the plurality of heaters are a plurality of urea heaters.

In yet another aspect of the present invention, the plurality of heaters are a plurality of NOx heaters.

In yet another aspect of the present invention, the system further includes a vehicle control module for issuing a plurality of control signals to the high current device control module to active one of the plurality of glow plugs and the plurality of heaters.

In yet another aspect of the present invention, a computer area network for communicating the control signals from the vehicle control module to the high current device control module is provided.

Further aspects and advantages of the present invention will become apparent by reference to the following description and appended drawings wherein like reference numbers refer to the same component, element or feature.

### DRAWINGS

The drawings described herein are for illustration purposes only and are not intended to limit the scope of the present disclosure in any way.

FIG. 1 is a diagram of an embodiment of a system for controlling high current components in a motor vehicle.

### DETAILED DESCRIPTION

The following description is merely exemplary in nature and is not intended to limit the present disclosure, application, or uses.

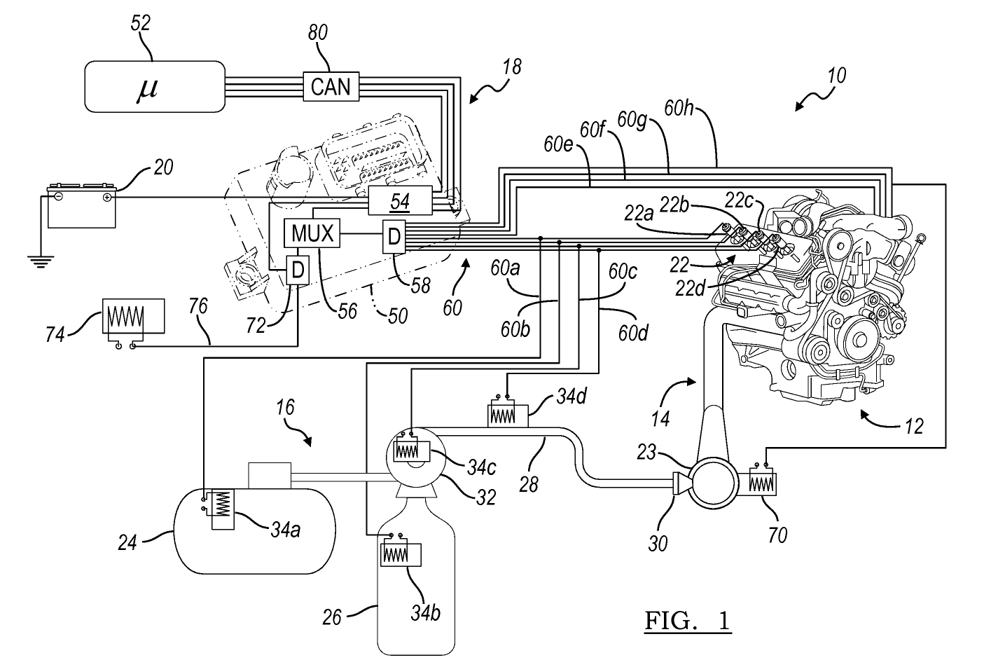

With reference to FIG. 1, a system for controlling high current components in a motor vehicle is illustrated and generally indicated by reference number 10. The system 10 generally includes, but is not limited to, a diesel engine 12, an exhaust system 14, a selective catalytic reduction (SCR) system 16, a control system 18, and a power source 20. The diesel engine 12 is an exemplary diesel engine using compression to achieve combustion within a combustion cylinder. The diesel engine 12 includes a plurality of high current heating components or glow plugs 22 located, for example, in each of the combustion cylinders of the diesel engine 12. The glow plugs 22 are used to pre-heat the engine block of the diesel engine 12 during cold start conditions. The diesel engine 12 includes eight glow plugs 22 in the example provided, however, only four glow plugs 22a, 22b, 22c, and 22d are illustrated in FIG. 1. Additionally, it should be appreciated that the diesel engine 12 may include any number of glow plugs 22 without departing from the scope of the present invention.

The exhaust system 14 includes an exhaust pipe 23 that is coupled to an exhaust manifold of the diesel engine 12. The exhaust pipe 23 receives an exhaust gas stream from the diesel engine 12 that is a by-product of the combustion process. The exhaust gas stream may include undesirable constituents, such as, for example, nitrogen oxides (NOx).

The SCR system 16 is employed to remove undesirable constituents from the exhaust gas stream. For example, the SCR system 16 includes a reductant tank 24 in communication with a reductant reservoir 26. The reductant tank 24 and reservoir 26 store a reductant or reducing agent that is employed to react with the undesirable constituents in the exhaust gas stream. For example, the reductant may be a urea compound that is capable of reacting with NOx in the exhaust gas stream. A transport line 28 is connected to the reductant tank 24 and the reductant reservoir 26 at one end thereof and to an injector 30 at an opposite end thereof. The injector 30 is in communication with the exhaust pipe 23. A pump 32 is connected to the reductant tank 24 and to the reductant reservoir 26. The pump 32 is operable to pump the reductant from the reductant tank 24 and the reductant reservoir 26 through the transport line 28 to the injector 30. The injector 30 is operable to disperse the reductant within the exhaust system 14 so that the reductant may react with undesirable constituents in the exhaust gas stream.

The SCR system 16 further includes a plurality of high current heaters including, for example, a tank heater 34a, a reservoir heater 34b, a pump heater 34c, and a line heater 34d. In the particular example provided, “high current” refers to an electrical current of approximately 13 amperes or higher, but other currents are possible depending on the requirements of a particular application. The tank heater 34a is located within the reductant tank 24, the reservoir heater 34b is located within the reductant reservoir 26, the pump heater 34c is located within the pump 32, and the line heater 34d is located within the transport line 28. The heaters 34a-d are used to heat the reductant within the SCR system 16, as will be described in greater detail below.

The control system 18 is employed to control and power the glow plugs 22 and the heaters 34a-d. The control system 18 includes a high current device control module 50 and a vehicle controller 52. The high current device control module 50 is, for example, a glow plug control module having a control circuitry 54 that may include circuits, sensors, microprocessors, data memory, and/or diagnosis devices. The control module 50 also includes a multiplexer 56 connected to the control circuitry 54 and a first plurality or set of drivers 58 connected to the multiplexer 56. The first drivers 58 are operable to supply a first power signal to activate the glow plugs 22 and a second power signal to activate the heaters 34a-d. The multiplexer 56 is capable of providing a control signal to the first drivers 58 to select which of the power signals are to be generated. Any known multiplexer device and method may be employed, such as, for example, frequency division multiplexing, time division multiplexing, etc. The number of individual drivers within the first set of drivers 58 is for example equal to the number of glow plugs 22 employed in the diesel engine 12.

A plurality of power supply lines 60 connects the first drivers 58 to the glow plugs 22 in the diesel engine 12. Therefore, in the example provided, the lines 60 include eight lines 60a-h. Additionally, the lines 60 connect or multiplex the heaters 34a-d of the SCR system 16 to the first drivers 58. For example, line 60a connects the tank heater 34a and glow plug 22a to one of the first drivers 58, control line 60b connects the reservoir heater 34b and glow plug 22b to another of the first drivers 58, control line 60c connects the pump heater 34c and glow plug 22c to yet another of the first drivers 58, and control line 60d connects the line heater 34d and glow plug 22d to still another of the first drivers 58.

Additional heaters or other high current components may be coupled to the control module 50, either by multiplexing to the first drivers 58 or through additional drivers. For example, a NOx heater 70 located in the exhaust system 14 may be connected or multiplexed to yet another of the first drivers 58 by control line 60h. It should be appreciated that the amount of heaters multiplexed to the system 10 may be equal to or less than the number of power supply lines 60. In another example, the control module 50 may include a second driver 72 connected to the control circuitry 54. An additional heating component 74, such as an intake air heater, may be connected to the second driver 72 by a power supply line 76.

The controller 52 is, for example, an engine control unit, vehicle control module, or other electronic device having a preprogrammed digital computer or processor, control logic, memory used to store data, and at least one I/O peripheral. However, other types of controllers may be employed without departing from the scope of the present invention. The controller 52 communicates control signals to the control module 50, for example via a computer area network 80.

The power source 20 is connected to and supplies a supply current to the control circuitry 54 of the control module 50. In the particular example provided, the power source 20 is a vehicle battery or series of batteries. However, various kinds of power sources may be employed so long as the power source 20 is operable to provide the minimum amount of power required to power the various components electrically coupled to the control module 50.

During operation of the system 10, the controller 52 signals the control module 50 to selectively activate the glow plugs 22 or the heaters 34a-d. For example, during cold start conditions, the controller 52 signals the control module 50 to activate the glow plugs 22 to preheat the diesel engine 12. During conditions where the reductant needs to be heated, for example when a urea reductant has frozen to an aqueous or solid state, the controller 52 signals the control module 50 to deactivate the glow plugs 22 and activate the heaters 34a-d to heat the reductant within the SCR system 16.

The description of the invention is merely exemplary in nature and variations that do not depart from the gist of the invention are intended to be within the scope of the invention. Such variations are not to be regarded as a departure from the spirit and scope of the invention.

1. A system for controlling high current devices for use in a vehicle having a diesel engine, the system comprising:
a power source for providing a supply current;
a first plurality of high current devices selectively connectable to the power source to receive the supply current;
a second plurality of high current devices selectively connectable to the power source to receive the supply current;
a high current device control module connected to the power source, the control module having a multiplexer circuit and a plurality of driver circuits connected to the first and second plurality of high current devices, wherein the multiplexer circuit is in communication with the plurality of driver circuits to selectively activate one of the first plurality of high current devices and the second plurality of high current devices.

2. The system of claim 1 wherein the plurality of driver circuits are equal in number to one of the first and second plurality of high current devices.

3. The system of claim 2 further comprising a plurality of control lines connected to the driver circuits, wherein the plurality of control lines are equal in number to one of the first and second plurality of high current devices.

4. The system of claim 1 wherein the first plurality of high current devices are a plurality of glow plugs.

5. The system of claim 4 wherein the second plurality of high current devices are a plurality of heaters.

6. The system of claim 5 wherein the plurality of heaters are a plurality of urea heaters.

7. The system of claim 6 wherein the plurality of urea heaters are coupled to a selective catalytic reduction system configured to introduce a reductant into an exhaust system connected to the diesel engine.

8. The system of claim 5 wherein the plurality of heaters are a plurality of nitrogen oxide heaters.

9. The system of claim 1 further comprising a vehicle control module for issuing a plurality of control signals to the high current device control module to active one of the plurality of glow plugs and the plurality of heaters.

10. The system of claim 9 further comprising a computer area network for communicating the control signals from the vehicle control module to the high current device control module.

11. A high current device control module for controlling a first and second set of high current devices, the first set of high current devices are operable to perform a first function and the second set of high current devices are operable to perform a second function in a vehicle having a diesel engine, the control module comprising:
a multiplexer circuit; and
a plurality of driver circuits connected to the first and second set of high current devices, and
wherein the multiplexer circuit is in communication with the plurality of driver circuits to selectively activate one of the first set of high current devices and the second set of high current devices.

12. The control module of claim 11 wherein the plurality of driver circuits are equal in number to one of the first and second set of high current devices.

13. The control module of claim 12 further comprising a plurality of control lines connected to the driver circuits, wherein the plurality of control lines are equal in number to one of the first and second set of high current devices.

14. The control module of claim 11 wherein the first set of high current devices are a plurality of glow plugs.

15. The control module of claim 11 wherein the second set of high current devices are a plurality of heaters.

16. The control module of claim 15 wherein the plurality of heaters are a plurality of urea heaters.

17. The system of claim 16 wherein the plurality of urea heaters are coupled to a selective catalytic reduction system configured to introduce a reductant into an exhaust system connected to the diesel engine.

18. The control module of claim 15 wherein the plurality of heaters are a plurality of nitrogen oxide heaters.
